(19) United States
(12) Patent Application Publication
(10) Pub. No.: US 2008/0013606 A1
(43) Pub. Date: Jan. 17, 2008

(54) Relay

(75) Inventors: Adrian Boariu, Irving, TX (US); Shashikant Maheshwari, Irving, TX (US); Shu Shaw Wang, Arlington, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/819,301

(22) Filed: Jun. 26, 2007

Related U.S. Application Data
(60) Provisional application No. 60/817,399, filed on Jun. 30, 2006.
(60) Provisional application No. 60/856,787, filed on Nov. 6, 2006.

(51) Int. Cl. H04L 25/20

(52) U.S. Cl. 375/211

(57) ABSTRACT

A relay for use in a communications network, said relay arranged to receive data from and transmit data to at least one higher level node and receive data from and transmit data to at least one lower level node, wherein the relay comprises: a processor arranged to control the relay so that within a relay time period the relay is arranged to a) transmit data to the at least one lower level node and transmit data to the at least one higher level node; and b) receive data from the at least one higher level node and/or receive data from the at least one lower level node, wherein the order of operation is a) then b).

### REFERENCE TO RELATED APPLICATION

This application claims priority of U.S. Provisional Application Nos. 60/817,399, filed on Jun. 30, 2006 and 60/856,787, filed on Nov. 6, 2006. The subject matter of the earlier filed applications is hereby incorporated by reference.

### BACKGROUND OF THE INVENTION

### Field of the Invention

The present invention relates to a relay, a method of forwarding signals and a communication system. The relay is in particular but not exclusively part of a multilevel relay chain.

Networks using relay units for forwarding of information are well known. In wireless networks such as cellular wireless networks, it is known to provide relay units for signals transmitted from base transceiver stations. In such arrangements the radio signal transmitted by a base transceiver station is received by a relay unit and is retransmitted by the relay unit, typically to a mobile terminal or other user equipment.

Currently, there is a challenge to ensure that there is sufficient coverage in a wireless network in order to provide high data rate services. With the current systems, usually only user equipment close to base stations have a potential for high data rates as the possible bandwidth which is limited by data error rates from the user equipment to the base station is strongly correlated to the inverse of the distance. Therefore in order to achieve high data rate coverage, a greater number of base stations are required. However, increasing the number of base stations is costly.

Relay units or relays have been proposed in order to distribute the data rate more evenly in the cell. However, there are problems associated with integrating relays or relay units into a wireless communication system.

One such problem is where the arrangement of the relays is organised in a tree arrangement. The root of the tree structure is the base station, the branch nodes of the structure are the relays or relay stations and the leaves of the structure are the user equipment. In such a structure a relay can be located both up and down stream of another relay. Relays can therefore be chained between the user equipment and the base station. As is known relays have defined time periods also known as a frame period within which data is transmitted to and received from relays downstream (also known as the downlink) i.e. towards/from the user equipment, and transmitted to and received from relays upstream (also known as the uplink) i.e. towards/from the base station. The frame period is important in transmitting data from relay to relay as it permits various time periods or frames to be allocated to various relays to prevent or reduce data collision or interference in the network. Such a system operating in such a way is known as a time division duplex (TDD) network. However problems occur where there are multiple links or data hops from the user equipment to the base station. In such systems the data transmitted by the user equipment has to perform several data hops to the base station with the associated problems in signal delay.

As described above a relay has to do within a single frame duration the following tasks: transmit and receive the data locally—i.e. the downlink communication, and transmit and receive the data pertained to the upper relay in the tree structure—the uplink communication. Current systems are the so-called one frame relay systems, and fit the sequence of the events—reception from upper relay in the tree structure, transmission locally, receiving locally and transmitting to the upper relay in the tree structure—into the duration of only transmission and reception of the upper relay in the tree structure. Thus, with each hop or link added, the above sequence of the events has to fit into a shorter allowable time period, imposing more constrains on the flow of data (with an additional inherent difficulty with this if hybrid automatic repeat request (ARQ) solutions are used in error correction due to accumulation of undelivered data). Furthermore as the duration of the local transmission (which is responsible for inserting the pilot tones) is decreased there is an additional probability of synchronization errors.

There is also a further problem where a relay is permitted to be nomadic, that while moving, the nomadic relay can enter into an area that is already covered by another relay and which operates with an overlapping time or frequency to the another relay. The overlapping can cause undesired interference for the user equipment.

### SUMMARY OF THE INVENTION

It is an aim of embodiment of the present invention to address or at least mitigate this difficulty.

There is provided according to the invention a relay for use in a communications network, said relay arranged to receive data from and transmit data to at least one higher level node and receive data from and transmit data to at least one lower level, wherein the relay comprises: a processor arranged to control the relay so that within a relay time period the relay is arranged to a) transmit data to the at least one lower level node and transmit data to the at least one higher level node; and b) receive data from the at least one higher level node and/or receive data from the at least one lower level node, wherein the order of operation is a) then b).

The relay time period is preferably defined from when the processor is first arranged to transmit data to the at least one lower level node to when the processor is further arranged to transmit data to the at least one lower node.

The at least one higher level node is preferably a base station, wherein the base station is preferably arranged within a base station time period to transmit data to the relay and receive data from the relay.

The start of the relay time period is preferably offset from the start of the higher node time period.

The relay period is preferably substantially equal to two times the base station time period.

The relay is preferably arranged to receive data transmitted from the base station transmitted during a first base station time period and transmit data to be received by the base station during a second base station time period.

The relay preferably transmits and receives data as orthogonally frequency division multiplexed (OFDM) symbols and wherein the start of the relay time period is offset from the start of the base station time period by more than one OFDM symbol.

The offset is preferably 4 OFDM symbols.

The at least one lower level node may comprise a further relay which comprises: a further relay processor arranged to control the further relay so that within a second relay time period the further relay is arranged to c) transmit data to a user equipment or lower level node, and transmit data to the relay; d) receive data from the relay and the user equipment and/or lower level node, wherein the order of operation is c), d).

The further relay time period is preferably defined from when the further processor is first arranged to transmit data to the user equipment to when the further processor is further arranged to transmit data to the user equipment.

The further relay time period is preferably equal to the relay time period.

The further relay time period is preferably offset from the relay time period.

The processor is preferably arranged to transmit data to the further relay, and receive data from the further relay within the relay time period.

The relay time period may comprise a first part period within which the operation a) is carried out and a second part period within which the operation b) is carried out, wherein the first part period and second part period are substantially equal to the base station period

The at least one lower level node may comprise a further relay which comprises: a further relay processor arranged to control the further relay so that within a second relay time period the further relay is arranged to c) transmit data to a user equipment or further lower level node, and transmit data to the relay; d) receive data from the relay and the user equipment and/or further lower level node, wherein the order of operation is c), d) and furthermore the further relay time period comprises a further relay first part period within which the operation c) is carried out and a further relay second part period within which the operation d) is carried out, wherein the further relay first part period and further relay second part period are substantially equal to the base station period.

The relay time period is preferably substantially equal to the base station period.

According to a second aspect of the invention there is provided a method for operating a relay, said relay arranged to receive data from and transmit data to at least one higher level node and receive data from and transmit data to at least one lower level node, wherein the method comprises: a) transmitting data to the at least one lower level node and transmitting data to the at least one higher level node; and b) receiving data from the at least one higher level node and/or receiving data from the at least one lower level node, wherein the order of method is a) then b) within a relay time period.

The relay time period is preferably defined from when the processor is first arranged to transmit data to the at least one lower level node to when the processor is further arranged to transmit data to the at least one lower node.

The at least one higher level node is preferably a base station, wherein the base station is preferably arranged to transmit data to the relay and receive data from the relay within a base station time period.

The start of the relay time period is preferably offset from the start of the base station time period.

The relay period is preferably substantially equal to two times the base station time period.

The relay is preferably arranged to receive data transmitted from the base station transmitted during a first base station time period and transmit data to be received by the base station during a second base station time period.

The relay preferably transmits and receives data as orthogonally frequency division multiplexed (OFDM) symbols and wherein the start of the relay time period is offset from the start of the base station time period by more than one OFDM symbol.

The offset is preferably 4 OFDM symbols.

The at least one lower level node preferably comprises a further relay, and the method preferably further comprises: c) transmitting data to a user equipment and transmit data to the relay; d) receiving data from the relay or the user equipment, wherein the order of operation is c), d) within a further relay period.

The further relay time period is preferably defined from when the further processor is first arranged to transmit data to the user equipment to when the further processor is further arranged to transmit data to the user equipment.

The further relay time period is preferably equal to the relay time period.

The further relay time period is preferably offset from the relay time period.

The data received in receiving data from the further relay is preferably received in response to data transmitted in transmitting data from the relay to the further relay within the relay time period.

The relay time period preferably comprises a first part period within which a) is carried out and a second part period within which b) is carried out, wherein the first part period and second part period are substantially equal to the base station period.

The further relay time period preferably comprises wherein the at least one lower level node comprises a further relay, and the method preferably further comprises: c) transmitting data to a user equipment and transmitting data to the relay; d) receiving data from the relay or the user equipment, wherein the order of operation is c), d) within a further relay period and a further relay first part period within which c) is carried out and a further relay second part period within which d) is carried out, wherein the further relay first part period and further relay'second part period are substantially equal to the base station period.

The relay time period is preferably substantially equal to the base station period.

According to a third aspect of the invention there is provided a network comprising a plurality of relays as claimed in any preceding claim.

According to a fourth aspect of the invention there is provided a computer program arranged to operate a computer to perform a method for operating a relay, said relay arranged to receive data from and transmit data to at least one higher level node and receive data from and transmit data to at least one lower level node, wherein the method comprises: a) transmitting data to the at least one lower level node and transmitting data to the at least one higher level node; and b) receiving data from the at least one higher level node and/or receiving data from the at least one lower level node, wherein the order of method is a) then b) within a relay time period.

The processor is preferably arranged to transmit a signature value associated with the relay.

The processor is preferably arranged to transmit a signature dependent on a message transmitted by the at least one higher level node.

The signature preferably comprises a first OFDM symbol comprising an identifier value.

The signature preferably further comprises a second OFDM symbol comprising a null value.

The first OFDM symbol preferably comprises a training sequence value.

The first OFDM symbol preferably comprises a training sequence value modified by a random or pseudo-random value.

### BRIEF DESCRIPTION OF DRAWINGS

For a better understanding of the present invention and as to how the same may be carried out, reference will now be made by way of example only to the accompanying figures in which:

FIG. 1 shows part of a communications network embodying the present invention;

FIG. 2 shows a relay unit embodying the present invention;

FIG. 3 shows a timing model in a network employing a “one frame relay system”;

FIG. 4 shows a timing model for a relay network utilised by a first embodiment of the present invention;

FIG. 5 shows a schematic view of OFDM symbols as used in a second embodiment of the present invention;

FIG. 6 shows a timing model for a relay network utilised by a third embodiment of the present invention;

FIG. 7 shows a timing model for a relay network utilised by a fourth embodiment of the present invention;

FIG. 8 shows a timing model for a relay network utilised by a fifth embodiment of the present invention; and

FIG. 9 shows a timing model for a relay network utilised by a sixth embodiment of the present invention.

### DETAILED DESCRIPTION OF PREFERRED EMBODIMENTS OF THE INVENTION

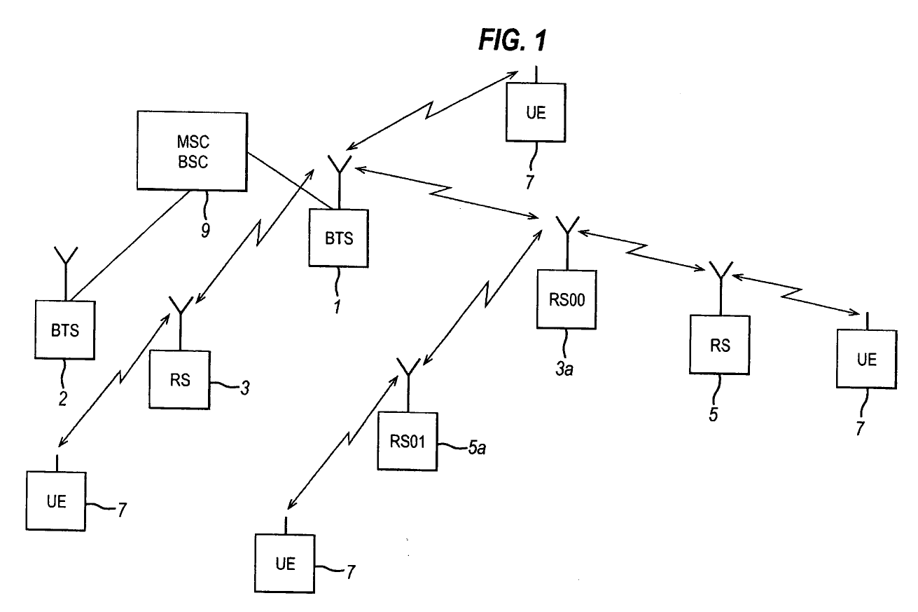

FIG. 1 shows a communication network arranged to incorporate an embodiment of the present invention. The communications network illustrated in FIG. 1 comprises base transceiver stations (BS) 1, 2 also known as base stations. The base stations (BS) 1, 2 are arranged to be capable of communicating with a base station controller (BSC) 9. In other embodiments the base stations are arranged to be capable of communicating with any known public land mobile network (PLMN) infrastructure. The base stations 1, 2 are also arranged to be capable of communicating with user equipment (UE) 7. The base stations are also arranged to be capable of communicating with relay stations (RS) 3,5.

The relay stations (RS) 3,5 are arranged to be capable of communicating with the base transceiver stations (BS) 1, 2. The relay stations are also capable of connecting to user equipment (UE) 7. The relay station (RS) 3a is also capable of communicating to other relay stations (RS) 5, 5a.

The general structure as shown in FIG. 1, is that there is a hierarchy of stations. At the highest point is the base station (BS). The base station may be connected to lower nodes for example to user equipment connecting directly to the base station, or relay stations connecting to the base station. Where the lower level node is a relay station, the relay station may be connected to further lower level nodes, e.g. user equipment or further relay stations, which are ranked lower than the relay station. Where the further relay station is connected to the relay station even further relay stations may be connected to the relay station at an even lower level.

In the above case the relay station can be considered to have a higher level node—the base station, and a lower level node—a further relay station and/or any user equipment connected directly to the relay station.

Furthermore the further relay station can be considered to have a higher level node—the relay station, and a lower level node—the even further relay station and/or any user equipment connected directly to the further relay station.

The linking of the relay stations is also shown in FIG. 1. FIG. 1 shows a first group of relay stations 3 (3 and 3a) that are connected directly to the base station 1 and a second group of relay stations 5 (5 and 5a) that are connected to the base station 1 via the first group of relay stations 3. Although not shown in FIG. 1 this chaining can be extended so that further groups of relay stations are connected to the base station via the previous groups of relay stations. To further assist the understanding of the present invention one of the first group of relay stations 3 has been given the reference value RS00 and one of the second group of relay stations 5 has been given the reference value RS01. These reference values are exemplary only and could be applied to any two chained relay stations—i.e. the below described examples can be applied to any two connected relay stations of adjacent groups.

The user equipment (UE), mobile station (MS) or subscriber station (SS) can be any suitable form of user equipment such as a mobile station, mobile telephone, personal organiser, PDA (personal digital assistant), computer, portable computer, notebook or the like.

In practice many more user equipment are provided. It should also be appreciated that in some embodiments of the invention a relay unit may be able to communicate with more than one base station.

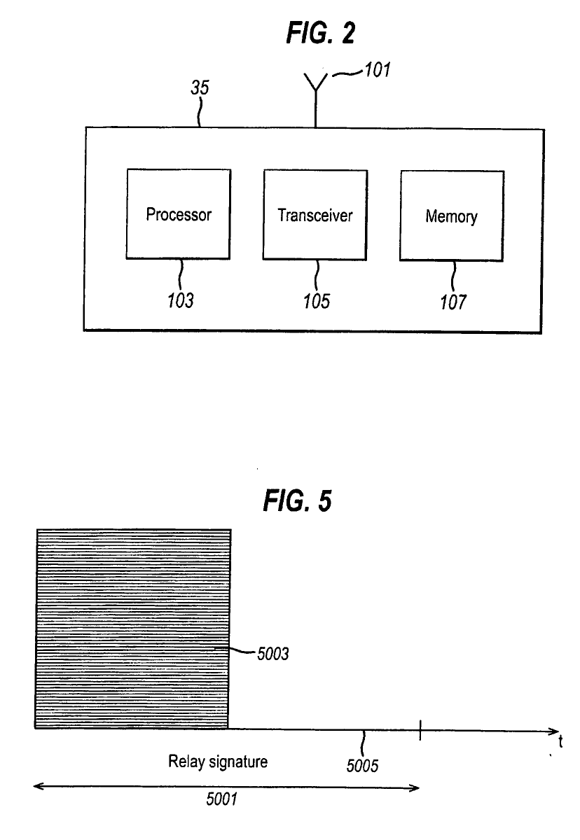

The relay station (RS) 3, 5 embodying the present invention is shown in more detail in FIG. 2. The relay station RS 3, 5 comprises an antenna 101 arranged to be capable of transmitting and receiving radio frequency signals from base station 1, user equipment 7 and other relay stations 3, 5. The antenna 101 may comprise an antenna array capable of beam forming and transmitting or receiving signals to or from a specific spatial direction.

The relay station RS further comprises a transceiver 105 connected to the antenna 101 and arranged to be capable of receiving radio frequency signals from the antenna and outputting base band signals and receiving base band signals and transmitting radio frequency signals to the antenna 101 for transmission.

The relay station RS 3,5 further comprises a processor 103 arranged to control the transceiver and for operating the relay station memory 107.

The relay station RS 3,5 further comprises memory 107, which is arranged to store instructions for the operation of the relay station 3,5. Furthermore the memory can be arranged to buffer received data prior to being re-transmitted to its destination. In some embodiments of the invention a separate memory may be used for storing different types of data, i.e. the received data may be stored on a magnetic storage media and the instructions stored on semiconductor memory devices.

It should be appreciated that the example of the relay station shown in FIG. 2 illustrates the functionality. It should be appreciated that aspects of the transceiver circuitry 105 may be incorporated in the processor 103 and vice versa.

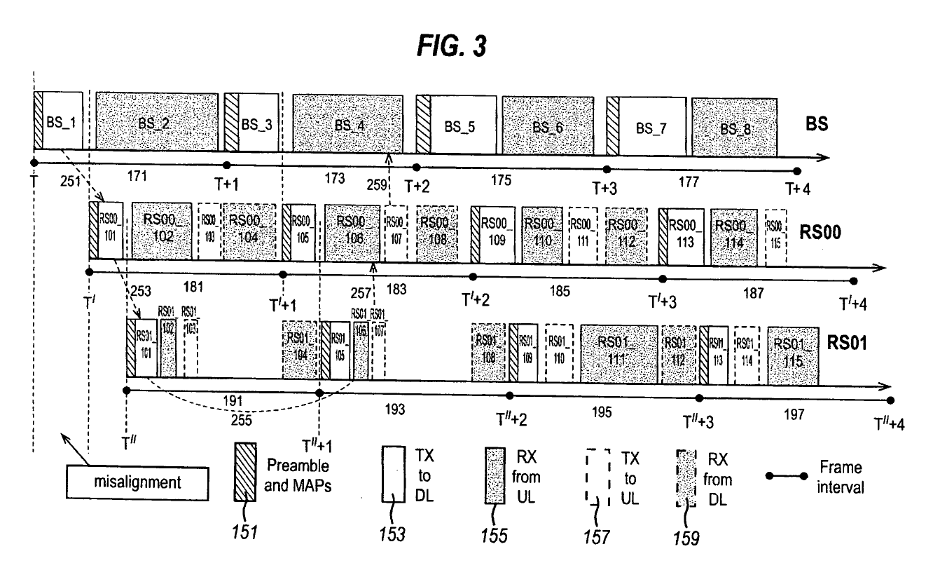

FIG. 3 shows a timing diagram showing the data flow between a base station (BS) 1 (which is arranged to be able to communicate with a first group relay station (RS00)), a first group relay station (RS00) 3 (which is arranged to be able to communicate with the base station (BS) 1, at least one second group relay station (RS01) 5 and user equipment), and a second group relay station (RS01) 5 (which is arranged to be able to communicate with the first group relay station (RS00) 3 and user equipment).

FIG. 3 shows 5 types of transmission. The solid, crosshatched boxes 151 represent preamble and mapping (MAP) data transmissions transmitted to the downlink connections. The solid, unfilled boxes 153 represent data transmitted (TX) to downlink (DL) connections, i.e. transmitted to the next level down. The solid, dot-filled boxes 155 represent data received (RX) from the uplink (UL) connections, i.e. received from the next level down. The dashed, unfilled boxes 157 represent data transmitted (TX) to uplink (UL) connections, i.e. transmitted to the next level up. The dashed, dot-filled boxes 159 represent data received (RX) from the downlink (DL) connections, i.e. received from the next level up.

FIG. 3 shows the transmission data flow for 4 frame periods. The first 2 frame periods show transmission and reception of data with interference mitigation. Interference mitigation prevents more than one network element from transmitting at the same time i.e. BS, RS00 and RS01 do not transmit at the same time. Also interference mitigation requires that uplink data transmitted by the relay stations are arranged such that the relay with the lower order in the tree structure transmits first. Thus in the first frame period the uplink transmission RS01_103 from RS01 to RS00 occurs before the uplink transmission RS00_103 from RS00 to BS.

The second 2 frame periods show transmission and reception of data without interference mitigation.

The four frame periods for the base station (BS) are T to T+1 (171), T+1 to T+2 (173), T+2 to T+3 (175), and T+3 to T+4 (177). For the first part 201, 203, 205, 207 of each frame period 171, 173, 175, 177 the BS transmits an initial preamble and MAP element and also transmits data on the downlink. The BS sets the beginning of the RS00 transmission frame such that the preamble and MAP data BS_1, BS_3, BS_5, BS_7 transmitted by the BS is received by the RS00 before a new RS00 frame interval 181, 183, 185, 187 starts.

The same process occurs with respect to the relationship between RS00 and RS01: The RS00, in the first part RS00_101, RS00_103, RS00_105, RS00_107 of each RS00 frame period 181, 183, 185, 187 transmits an initial preamble and MAP element and also transmits data on the downlink to the RS01 relay station. This initial preamble and MAP element from the RS00 relay station sets the beginning of each RS01 frame period 191, 193, 195, 197. Thus the RS00 schedules the data pertaining to RS01 on downlink before a new RS01 frame starts.

Similar processes occur with respect to the relationship between RS01 and any further layer of relay station.

For each level downstream from the base station (BS) there is therefore a misalignment of the frame period due to the transmission time between the transmission of the initial preamble and MAP data and the reception of the data. This is represented by the timing differences of T for the start of the BS frame period, T′ for the start of the RS00 frame period and T″ for the start of the RS01 frame period.

Each of the four frame periods 171, 173, 175, 177 for the base station also comprise a period BS_2, BS_4, BS_6, BS_8 within each frame at which time it receives data from the uplink—i.e. it receives data from the RS00 relay station and any other relay station and UE also arranged to communicate to it.

Each of the four frame periods 181, 183, 185, 187 for the first level relay station RS00 comprise a period RS00_102, RS00_106, RS00_110, RS00_114 within each frame at which time it receives and processes data from the uplink—i.e. from the RS01 and any UE attached to RS00. Further each of the four frame periods 181, 183, 185, 187 for the first level relay station RS00 comprise a period RS00_103, RS00_107, RS00_111, RS00_115 within each frame at which time it processes and transmits data to the uplink—i.e. to the BS. Further each of the four frame periods 181, 183, 185, 187 for the first level relay station RS00 comprise a period RS00_104, RS00_108, RS00_112, (the final frame period is not shown) within each frame at which time it receives and processes data from the downlink—i.e. from the BS.

Each of the four frame periods 191, 193, 195, 197 for the second level relay station RS01 comprise a period RS01_102, RS01_106, RS01_111, 415 within each frame at which time it receives and processes data from the uplink—i.e. from the UE or further level relay station (not shown). Further each of the four frame periods 191, 193, 195, 197 for the second level relay station RS01 comprise a period RS01_103, RS01_107, RS01_110, RS01_114 within each frame at which time it processes and transmits data to the uplink—i.e. to the RS00. Further each of the four frame periods 191, 193, 195, 197 for the second level relay station RS01 comprise a period RS01_104, RS01_108, RS01_112, (the final frame period is not shown) within each frame at which time it receives and processes data from the downlink—i.e. from the RS00.

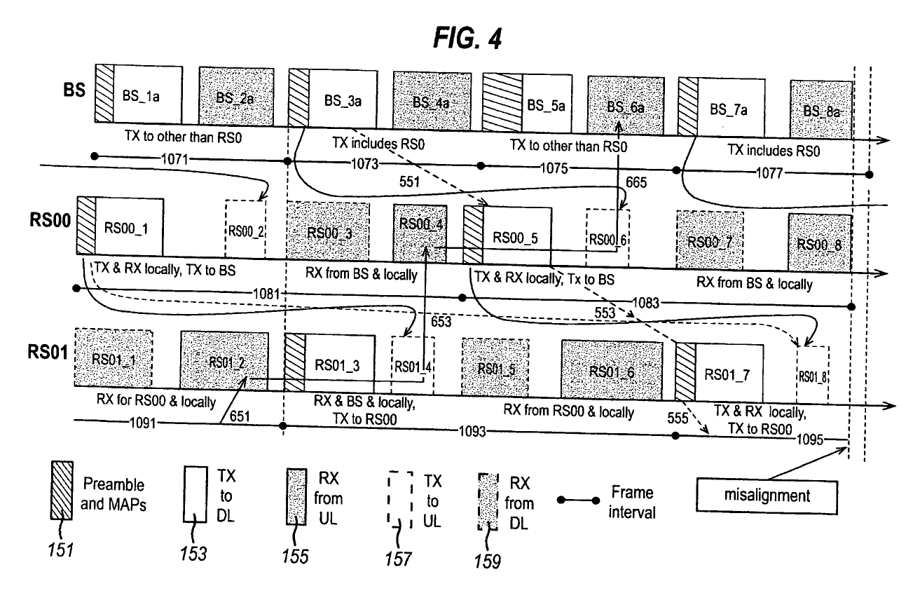

As can be seen in FIG. 3 and in embodiments of the invention shown in FIGS. 4, 6, and 7 the start of the block when the higher level node transmits to the lower level node [i.e. the solid, unfilled boxes 153 representing data transmitted (TX) to the downlink (DL) connection], is aligned with start of the block when the lover level node begins receiving data from the higher level node [i.e. the dashed, dot-filled boxes 159 represent data received (RX) from the downlink (DL) connections].

A succession of the events is shown in FIG. 3 by dashed-line arrows. In a first event 251, the transmission 201 from BS is received by RS00. In response to this data, RS00 transmits data RS00_101 that is received by RS01, in the second event 253. In response to data RS00_101, RS01 transmits data RS01_101 to the locally attached UEs and receives data RS01_106 from the locally attached UEs in event 255. In response to event 255 the RS01 transmits data RS01_107 in event 257. In event 259, in response to receiving the data from the RS01 the RS00 transmits data RS00_107 to the BS. Thus the BS receives the data in the next frame, i.e. the entire tree of relays behaves as if a single UE was connecting to a BS.

This process however has the drawback that the lower order relays have shorter time to operate.

One approach to overcome this problem has been to allow transmission without interference mitigation, as can be seen in the second two frames of FIG. 3. Using this approach RS00 can transmit locally (i.e. to transmit using the downlink) at the same time as the BS transmits to the RS00. Also an uplink receive delay following the downlink transmission is introduced by reversing the order of the TX to UL and RX from UL periods in the RS01, so that it can be seen that RS01 transmits on uplink first RS01_110, RS01_114 and afterwards receives the uplink data from local UEs RS01_111, RS01_115. In this situation the tree of relays can be expanded at the expense of increasing the maximum delay in the system.

However these methods have additional disadvantages. The BS cannot change the transmission/reception ratio without affecting the interference at the attached relays. There is an increase in schedule complexity for the BS and RS in order to avoid simultaneous transmissions overlapping and causing interference. In the case of operating the tree of relays with minimum delay, there are strict requirements for scheduling at BS and relays, and the relays of lower order in the tree have longer idle times of operation. Further for a maximum delay period the number of hops of the tree of relays is limited.

FIG. 4 shows the a timing diagram showing data exchanges between the BS and the relay stations RS00 and RS01 in a first embodiment of the present invention.

In FIG. 4 the same types of process are given the same reference numeral as shown in FIG. 3.

With regards to the base station BS, four frame periods 1071, 1073, 1075, 1077 are shown. As previously shown in FIG. 3, within each frame period 1071, 1073, 1075, 1077 the base station is arranged to transmit data on the downlink as can be seen in data transmissions BS_1a, BS_3a, BS_5a, BS_7a, and receive data from the uplink of the level below BS_2a, BS_4a, BS_6a, BS_8a. However the base station is arranged to only transmit data to the relay station RS00 every other frame 1073 (BS_3a), 1077 (BS_7a), and to receive data from the relay station RS00 in the base station frames between the transmit frames 1071 (BS_2a), 1075 (BS_6a).

The frame arrangement in the RS differs from that as shown in FIG. 3 in several ways.

Firstly the processor for each RS controls the frame length so that the frame length of each RS is twice the length of the frame length of the BS. In FIG. 4 there are shown two RS00 frame periods 1081, 1083. The first RS00 frame period is roughly aligned with the BS frame periods 1071 and 1073, and the second RS00 frame period is roughly aligned with the BS frame periods 1075 and 1077.

Furthermore FIG. 4 shows a partial RS01 frame period 1091 which is roughly aligned with the BS frame period 1071 and a previous not shown BS frame period, a complete RS01 frame period 1093 which is roughly aligned with the BS frame periods 1073 and 1075, and a further partial RS01 frame period 1095 which is roughly aligned with the BS frame period 1077 and a subsequent (not shown) BS frame period.

Secondly the processor for the first level RS controls an offset for the start of each frame so that there is a misalignment between the start of the RS00 frame relative to the start of the BS frame it is roughly aligned with, as it is shown at the bottom right of FIG. 4. This misalignment is arranged so that the RS00 and BS can be arranged to transmit the respective preambles of the data transmissions without interfering.

In embodiments of the present invention the transmission resources can be divided into time units such as OFDM symbols, in such embodiments the relay time period is offset from the base station time period by at least one OFDM symbol duration. A preferable offset of 4 OFDM symbols can in embodiments of the invention provide an acceptable guard space between the transmitted preambles.

FIG. 4 shows the processor producing a negative offset, i.e. the preamble of RS00 occurs before the preamble of the BS. In other embodiments of the invention a positive offset can be set by the processor so that the preamble of RS00 occurs after the preamble of the BS.

The processor controlling the second and further level RS also controls the start of each level frame period relative to the start of the preceding level frame period to reduce the interference between preambles. As it can be seen in FIG. 4, the preamble of the RS01 relay station and the RS00 relay station are offset, however the preambles of the RS01 relay station and BS can be aligned as can be seen by the BS frame 1073 and the preamble BS_3 and the RS01 frame 1093 and the preamble RS01_3.

Thirdly the processor controls the length of the downlink transmissions in the RS so that the downlink transmission durations for the BS and RS, during which data can be transmitted to the lower level or local data, are fixed.

Fourthly the processor is arranged to be able to handle uplink mapping (UL-MAP) information transmitted during a frame, where the UL-MAP information defines how and when the user equipment (UE) or subscriber stations (SS) can transmit during the following frame.

As can be shown in FIG. 4 each first level relay station RS00 frame period 1081, 1083 comprises a period RS00_01, RS00_05 within each frame at which time it transmits (TX) data to the downlink (DL)—i.e. to a lower level of RS or associated UE. Following this TX DL period each RS00 frame period comprises a period RS00_02, RS00_06 at which time it transmits (TX) data to the uplink (UL)—i.e. to the BS. Following this TX UL period each RS00 frame period comprises a period RS00_03, RS00_07 at which time it receives (RX) data from the downlink (DL) of the higher level, i.e. from the BS. Finally following this RX DL period each RS00 frame period comprises a period RS00_04, RS00_08 at which time it receives (RX) data from the uplink (UL) of a lower level, i.e. from the RS01.

Similarly with regards to the second level relay station RS01, each frame period, has a first period RS01_03, RS01_07 when it transmits (TX) data to the downlink (DL)—i.e. to a lower level of RS or associated UE, a following period RS01_04, RS01_08 at which time it transmits (TX) data to the uplink (UL)—i.e. to the RS00, a further following period RS01_01, RS01_05 when it receives (RX) data from the downlink (DL) of a higher level, i.e. from the RS00, and a further following period RS01_02, RS01_06 when it receives (RX) data from the uplink (DL) of a lower level, i.e. from the UE.

To further assist in understanding the operation of the invention an example of the data flow using FIG. 4 is further described below.

The BS considers the RS00 as a subscriber, and as described above transmits data every second BS frame to the RS00, and receives data from the RS00 on the uplink during the subsequent BS frame. For example, the RS00 receives data from BS during the periods RS00_3, RS00_7. Also the RS00 responds to the transmission during the period BS_3 which contains the UL-MAP information for the next BS frame duration, i.e. the BS receives the data transmitted in period RS00_6 during the period BS_6.

During the BS frame periods that the RS00 is not scheduled to receive data from the BS, the RS00 performs its “local” duties, i.e. communicates with its local UEs and lower level RSs such as RS01. Thus RS00 transmits locally during RS00_1 and RS00_5. As FIG. 4 shows, the RS00 frame period is divided into a first part where there is a transmission downlink and uplink, followed by a second half where there is a reception from uplink and downlink.

Attaching the relay RS01 to the relay RS00, i.e. increasing the number of hops is also demonstrated with respect to FIG. 4. As described above the RS01 frame can be realigned with that of the BS frame, though the start of the RS01 frame is offset to match the BS transmission that includes the transmission to the RS00 relay station preamble—this can be observed from alignment of the blocks BS_3 and RS01_3.

In embodiments of the invention as described above, for each hop added to the system, the one-way propagation delay increases by one frame duration. For example on the downlink, data transmitted 551 at BS_3 can be relayed 553 at RS00_5 and finally relayed 555 at RS01_7. Similarly for uplink, data received at RS01_2 in step 651 can be received at RS00_4 in step 653 and finally received at BS_6 in step 655. Therefore the shortest one way delay for the above example is 3 BS frames. However, this is possible in this embodiment if the relays use some preemptive scheduling, at least for uplink. For example, if RS01 receives data at RS01_2 and right away transmits the data on the uplink in RS01_4. In other words, the relay operates with a margin of safety with respect to requested data rates in order to accommodate real-time traffic efficiently. Preemptive operation is suited for decentralized relays that have assigned in the uplink transmission a zone that can be filled with data from desired UE, and the relays are also quality of service (QoS) aware.

In embodiments of the present invention although the additional of further hops or links introduces extra delay it overcomes the problem discussed with relation to the system as discussed in FIG. 3, where additional chaining required the added chains to perform their relaying task with shorter and shorter periods. Therefore by removing the timing limitation it is possible to install several chains of links without requiring expensive and computationally complex components.

The delay in replying from RS01 to a request from RS00 can also be shown in FIG. 4. As discussed above the UL-MAP transmitted on the downlink refers to the reception on the next frame. Thus the downlink transmission of UL-MAP in RS00_1 refers to uplink reception of period RS01_8 in the interval of RS00_8, as the dashed arrow shows. Thus, the local delay experienced by a UE attached to a relay is two BS frame durations greater than that of a UE attached directly to the BS.

In a further embodiment of the present invention it is possible to reduce this delay, by arranging the processor to reply to the UL-MAP within the same RS frame interval. For example, as the continuous arrows in FIG. 4 show, the downlink transmissions RS00_1 and RS00_5 are paired with uplink transmissions RS01_4 and RS01_8, respectively. In one embodiment of the invention the parameter Allocation Start Time present in the UL-MAP message should be set accordingly by the processor. In embodiments is should be possible in terms of processing time to support an Allocation Start Time less than the frame duration, because the relay frame duration is already twice that of the BS.

Thus in summary the embodiments described in relation to FIG. 4 have the advantages:

The operation is truly transparent to the local UE.

Attaching a relaytoarelay is straightforward.

Works well with distributed scheduler. However, the BS can centralize how the attached tree of relays use the frequency subchannel groups to minimize the frequency reuse factor in the cell/sector.

The BS can change the transmission/reception ratio without affecting the attached relays.

These embodiments support a tree of relays of any size, at the expense of increasing the delay.

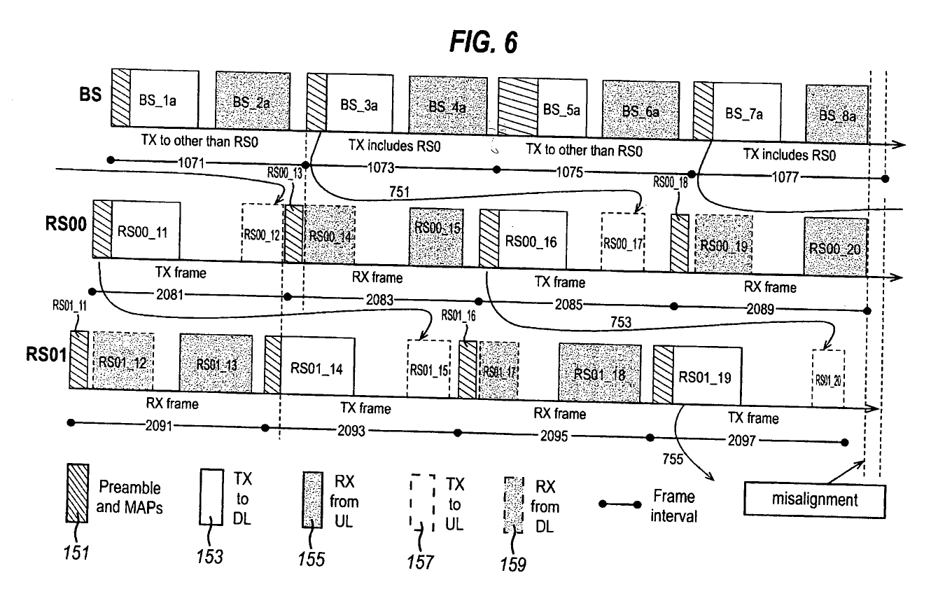

FIG. 6 shows a further timing diagram demonstrating a further embodiment of the present invention.

In FIG. 6 the same types of process are given the same reference numeral as shown in FIGS. 3 and 4.

With regards to the base station BS, four frame periods 1071, 1073, 1075, 1077 are shown. As previously shown in FIG. 4, within each frame period 1071, 1073, 1075 the base station is arranged to transmit data on the downlink as can be seen in data transmissions BS_1a, BS_3a, BS_5a, BS_7a, and receive data from the uplink of the level below BS_2a, BS_4a, BS_6a, BS_8a. However the base station is arranged to only transmit data to the relay station RS00 every other BS frame 1073 (BS_3a), 1077 (BS_7a), and to receive data from the relay station RS00 in the base station frames between the transmit frames 1071 (BS_2a), 1075 (BS_6a). Thus the base station performs no differently than in the embodiment demonstrated in FIG. 4.

The frame arrangement in the RS differs from that as shown in FIG. 4 in several ways.

Firstly the processor for each RS controls the frame length so that the frame length of each RS is the same frame length of the BS. Furthermore each frame is alternately a transmit frame (TX) or a receive frame (RX). Thus for the RS00 there are shown two TX frames 2081, 2085, and two RX frames 2083 and 2087 which occur in the order TX frame 2081, RX frame 2083, TX frame 2085 and RX frame 2087.

At the start of each RS frame is a preamble and MAP data period which is transmitted via the downlink. Each RS TX frame also comprises a TX to DL component and a TX to UL component which are similar to the TX to DL and TX to UL components as described above. Each RS RX frame also comprises a RX from DL component and RX from UL component which are similar to the RX from DL and RX from UL components as described above. The preambles with their mappings for the RS RX frames (RS00_13, RS00_18, RS01_11 and RS01_16) are inserted to define the same frame duration as the BS, however in embodiments these preambles have empty mappings for uplinks and downlinks, because their corresponding frames do not permit transmission.

Secondly the processors for the first level RS and second level RS control an offset for the start of each frame so that there is a misalignment between the start of the RS00 frame relative to the start of the BS frame, and similarly between the start of the RS01 frame relative to the start of the RS00 frame as it is shown at the bottom right of FIG. 6. This misalignment is arranged so that the RS00, RS01 and BS can be arranged to transmit the respective preambles at the start of the frame without interfering with each other. In embodiments of the present invention the offset is at least one OFDM symbol duration, but a preferable offset of 4 OFDM symbols provides an acceptable guard space between the transmitted preambles. FIG. 4 shows the processor producing a negative offset, i.e. the preamble of RS00 occurs before the preamble of the BS, and the preamble of RS01 occurs before the preamble of RS00.

Thus a second difference over the embodiments shown in relation to FIG. 4 are that the start of the RS01 frames are no longer aligned with the start of the BS frame; as they are misaligned relative to the frames of RS00. If the RS01 frames would be aligned with the BS frames, then the transmission of RS00_16 would overlap with the transmission of the preamble RS01_16, and prevent RS01 from being capable of receiving RS00_16.

In the embodiments described above each hop or link added, causes the one-way delay to increase by one frame. For example, the data transmitted on BS_3 to RS00, can be retransmitted at RS00_16 to RS01, which at its turn can be retransmitted to the UE at RS01_19. Therefore the delay time introduced by each added hop or link is approximately half that introduced from the embodiment described above.

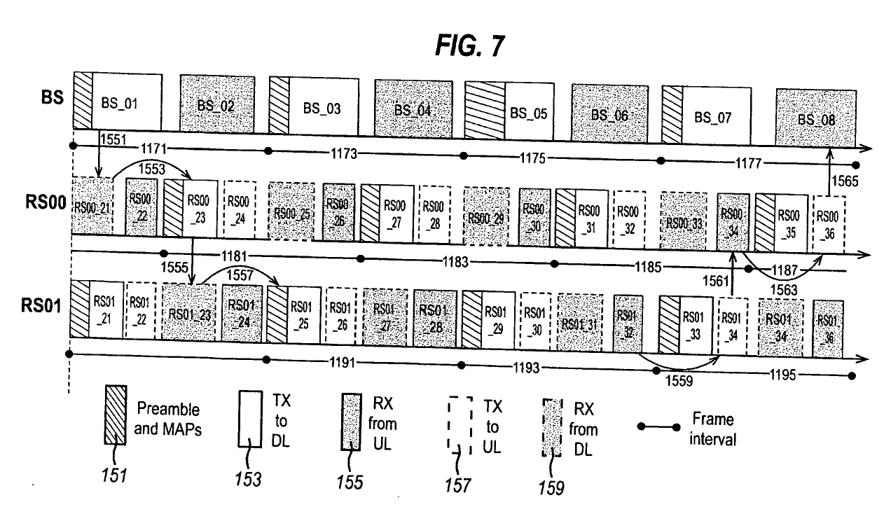

FIG. 7 shows a timing diagram demonstrating the methods used in further embodiments of the present invention.

FIG. 7 shows the option of a relay tree structure that offers some flexibility of adjusting the frame transmission/reception structure at the expense of increasing the propagation delay. These embodiments of the present invention have a frame structures which is a hybrid of the frame structures shown in FIGS. 3 and 6.

For example the BS frame structure is the same as described with regards to FIG. 3 as described above where every frame data is transmitted to the first level relay station.

The structure of the RS frame structure differs from the RS frame structure of FIG. 3 in that the RS processor is arranged to start a new frame after the DL transmission from the level above. Thus the RS00 frame 1181 is started after the BS frame TX to DL period BS_1 in BS frame 1171. Furthermore this structure allows the second tier relays to have their frames aligned with that of the BS.

The frame structure of the RS is similar to that as previously described above with reference to FIG. 3, except the ordering of the periods comprising each frame is similar to that shown in embodiments of the invention as described in FIGS. 4 and 6.

Thus each relay station frame period 1181, 1183, 1185, 1187, 1191, 1193, 1195 comprises a first period at which time it transmits (TX) data to the downlink (DL)—i.e. to the lower level of RS or associated UE. Following this TX DL period each RS frame comprises a period at which time it transmits (TX) data to the uplink (UL)—i.e. to the BS or to a higher level. Following this TX UL period each RS frame comprises a period at which time it receives (RX) data from the downlink (DL) of the higher level, i.e. from the BS or higher level of RS. Finally following the RX DL period each RS frame comprises a period at which time it receives (RX) data from the uplink (UL) of the lower level, i.e. from the lower level of RS or associated UE.

This frame structure forces the processors to arrange that the transmission/reception ratio be close to one as any unbalance would cause the later frames to slip. Furthermore the processors in the relays and BS have to give high priority to the next lower level relay stations when transmitting on the downlink. For example, the BS in period BS_1 has to schedule the data for RS00 before the period RS00_22 begins the local uplink reception. Also, the BS has to schedule the uplink reception for its first tier relays at the end of the frame interval, as can be observed from reception of RS00_24.

This arrangement has the further advantage over the embodiments of FIG. 6 in that the one-way propagation delay introduced by adding a link is a half of that in FIG. 6, i.e. two hops produce a one way propagation delay of one frame. For example BS transmission 1551 at period BS_1 is received at RS00_21, processed 1553, and is transmitted 1555 at RS00_23 to be received RS01_23, processed 1557 and is able to be transmitted to the UE at RS01_25.

FIG. 5 shows a further embodiment of the invention which can be implemented as part of the inventions as described above with regards to the embodiments of the invention as shown in FIGS. 4, 6 and 7 above.

The relay station is arranged to signal its presence to other relays and/or detect the presence of other relays that may interfere with the relay station.

As has been described previously, the beginning of each frame comprises preamble and MAP data. Each frame for all relays that belong to a certain level or tier of relay have their preamble and MAP data transmitted at the same time. Furthermore it is not possible to remove the transmission of the preamble and MAPs at the beginning of the frame, in at least the (WiMAX) embodiments described above as without this information any user equipment connected to the relay station is not able to configure the communication link between the relay station and user equipment.

FIG. 5 shows as an example of a schematic view of a relay signature which can be transmitted by a relay station in order for the relay station to be detected by other relay stations.

FIG. 5 shows as an example of two consecutive OFDM symbols 5003, 5005 that form the signature of the relay. The first OFDM symbol 5003 comprises the actual ‘signature’ associated with and identifying the relay station. The second OFDM symbol 5005 is a blank symbol, permitting the RS to switch to the reception mode.

The signature can be transmitted if and when the BS requests a identifier for the relay station. The signature can be located within the frame structure as described above and can be arranged to be located in the frame structure by the relay or relay processor in dependence of information transmitted by the BS. In preferred embodiments of the invention the signature is not located within the frame structure when the RS is in a RX mode.

The first OFDM symbol 5003, comprises known pilot tones at a known pattern positions to identify an RS uniquely.

Thus as at least one of the relay stations employs a different pattern of positions of pilot tones from a pattern of position of pilot tones transmitted by another relay station, potentially interfering relay station.

The pilot position assignment in the frequency domain of the OFDM symbol is generated as the sum of a pattern position arrangement. For example each relay station pilot position assignment is equally or substantially equally spaced from all other known relay station pilot position assignments. Furthermore a small dither (randomness) is added to each position.

Thus from this arrangement and dithering a set of pilot positions can be generated of which one is assigned to each RS for the purpose of identification. Furthermore any two RS are separated based on their signature (actually pilot positions) if their pilot positions have no position in common.

Therefore preferable embodiments generate the set of pilot positions so that any two combinations of pilot positions intersect a relative small number of times, and preferably are mutually exclusive.

The relay signature is preferably located at the end of the transmission block interval of the frame structure of the relay, in order to allow a natural switch from transmission mode into reception mode.

For example considering the frame structure as shown in FIG. 7, with regards the relay station RS00, the relay signature can be inserted at the end of the blocks RS00_24, RS00_28, RS00_32, etc.

Also, because this signature has a fixed position relative to the beginning of the frame in order to be easily identified by other RS, it is preferably located two OFDM symbols before the transmission of the upstream RS/BS starts, i.e. in our considered example two OFDM symbols before the blocks BS_3, BS_5, BS_7, etc., start. This allows a smooth transition of the RS00 into reception mode.

Note that this relay signature can be transmitted periodically, or at the request of other superior entities (e.g. BS or Relay station from a higher level) that provided some management to the network.

Therefore the above embodiment provides a solution to the problem of RS presence discovery when nomadic or portable RS are present in the system. As there is embedded directly into the RS frame structure a signature that identifies uniquely an RS, this provides information to the system as a whole as to which RSs are the neighbors of a given RS.

Thus, in the event of a nomadic RS approaching to an RS that operates in an overlapping time-frequency dimension, which can cause mutual interference, the BS or other management function can adjust some RS parameters of the involved RSs (even turning off one of them) to avoid the interference situation.

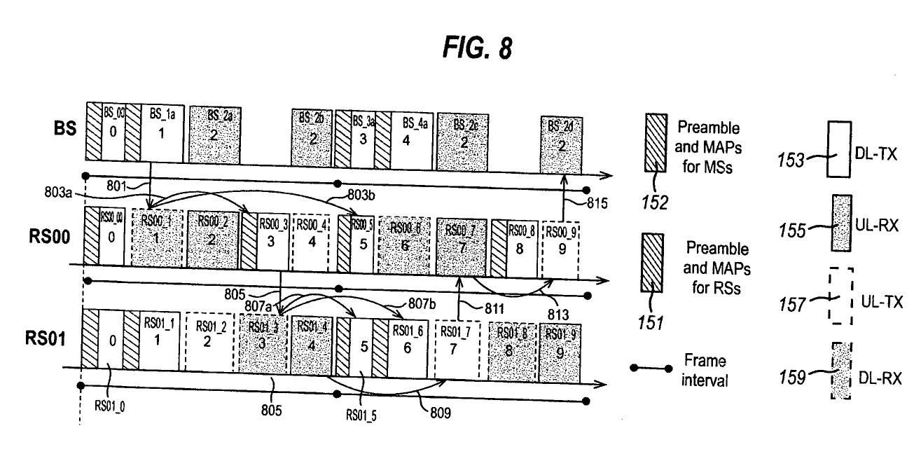

FIG. 8 shows a further embodiment of the present invention. The further embodiment of the present invention is similar to that described above with respect to FIG. 7.

]. FIG. 8 also shows a relay tree structure that offers some flexibility of adjusting the frame transmission/reception structure at the expense of increasing the propagation delay.

The structure of the BS and RS frame structures differ from the BS and RS frame structure of FIG. 7 in that the time frames for all of the BS and RS are synchronized by the transmission from the BS of data to the RS and any UE beneath the BS.

The synchronization of the frame periods of the RS and BS has the specific advantage that any UE can easily carry out a simple handover between RSs downstream of a specific BS and from RS to BS where the RS is downstream of the BS, in other words receives data from that specific BS. The handover is simplified as the preambles are aligned.

As can be seen in FIG. 7. This alignment is arranged by the upstream BS or RS transmitting to the downstream RS an initial block. The BS transmits blocks BS_00 and BS_03 to the RS00 with the preamble and MAPs for the UE 152. These are received and retransmitted downstream from RS00 to RS01 in blocks RS00_0 and RS00_5, and from RS00 further downstream in blocks RS01_0 and RS01_5.

The BS in a frame interval also transmits a data block containing the preamble and MAP for the RSs to RS00 as can be seen in block BS_1a (and also in the next frame BS_4a), and receives data from the RS00 as can be shown in block BS_2a, and BS_2b (and BS_2c, BS_2d).

RS00, the relay station directly downstream of the BS, as well as receiving the synchronization block and transmitting the synchronization block downstream, also carries out the following actions within the same frame interval.

Receiving a data block from the BS in block RS00_1 (also block RS00_6). Receiving a data block from the downstream RS in RS00_2 (also block RS00_7). Transmitting a data block to the downstream RS in RS00_3 (also block RS00_8). Transmitting a data block to the upstream BS in RS00_4 (also block RS00_9).

The order of these blocks in a frame interval is RS00_1, RS00_2, RS00_3, RS00_4 (and in the subsequent frame interval RS00_6, RS00_7, RS00_8, RS00_9).

RS01, the relay station directly downstream of RS00, as well as receiving the synchronization block and transmitting the synchronization block downstream, also carries out the following actions within the same frame interval.

Transmitting a data block to the downstream RS (or UE) in RS01_1 (also block RS01_6). Transmitting a data block to the upstream RS00 in RS01_2 (also block RS01_7). Receiving a data block from the upstream RS RS00 in block RS01_3 (also block RS01_8). Receiving a data block from the downstream RS (or UE) in RS01_4 (also block RS01_9).

The order of these blocks in a frame interval is RS00_1, RS00_2, RS00_3, RS00_4 (and in the subsequent frame interval RS00_6, RS00_7, RS00_8, RS00_9).

In some embodiments of the invention the preambles directed to the UEs can be different from the preambles directed to the RSs. Embodiments of the invention using this have no ambiguity in when the frame starts as this is linked to the preamble directed to the UEs only.

The arrows show a typical data flow in this embodiment of the invention. As can be seen from FIG. 8, the frame structure with different preambles produces different delays on the downstream dependent on whether the downstream element is a RS or UE. In FIG. 8 the a referenced arrows show the data path for RS to RS transmissions and the b referenced arrows show the data path for the RS to UE transmissions.

In some embodiments of the present invention, there is no further RS downstream of RS01. In these embodiments the RS can reutilize the periods RS01_1 and RS01_6 as UE transmission blocks. Thus the amount of time available to transmit to the UE is increased within any time frame. Similar transmission improvements can be made if there was no RS01 RS, in which case the RS00 could reallocate the periods RS00_3 and RS00_8 to UE transmission.

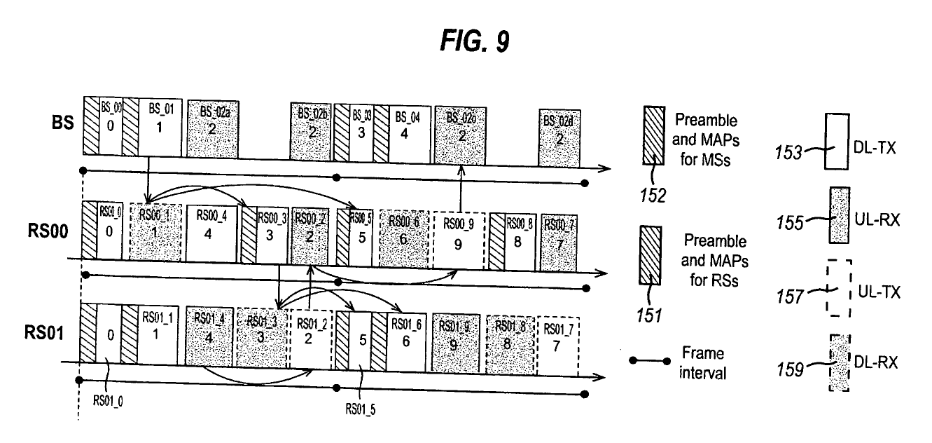

FIG. 9, shows a further embodiment of the present invention which is similar to that shown in FIG. 8. The primary difference between the process shown in FIG. 8 and the embodiment shown in FIG. 9 is that the ordering of the blocks RS00_2, RS00_4 is switched (and also RS00_7 and RS00_9). Also the ordering of blocks RS01_2, RS01_4 is switched (and also RS01_7 and RS01_9).

The above described operations may require data processing in the various entities. The data processing may be provided by means of one or more data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a location server.

It is noted that whilst in the above embodiments are described in relation to user equipment such as mobile stations, embodiments of the present invention are applicable to any other suitable type of user equipment.

It is also noted that even though the exemplifying communication system shown and described in more detail in this disclosure uses the terminology of the WiMAX system, embodiments of the proposed solution can be used in any communication system wherein advantage may be obtained by means of the embodiments of the invention. The invention is not limited to environments such as cellular mobile or WLAN systems either. The invention could be for example implemented as part of the network of computers known as the “Internet”, and/or as an “Intranet”. Furthermore the user equipment 14 in some embodiments of the present invention can communicate with the network via a fixed connection, such as a digital subscriber line (DSL) (either asynchronous or synchronous) or public switched telephone network (PSTN) line via a suitable gateway.

It is also noted that while the above describes exemplifying embodiments of the invention, there are several variations and modifications which may be made to the disclosed solution without departing from the scope of the present invention as defined in the appended claims.

1. A relay for use in a communications network, said relay arranged to receive data from and transmit data to at least one higher level node and receive data from and transmit data to at least one lower level, wherein the relay comprises:
a processor arranged to control the relay so that within a relay time period the relay is arranged to
a) transmit data to the at least one lower level node and transmit data to the at least one higher level node; and
b) receive data from the at least one higher level node and/or receive data from the at least one lower level node,
wherein the order of operation is a) then b).

2. A relay as claimed in claim 1, wherein the relay time period is defined from when the processor is first arranged to transmit data to the at least one lower level node to when the processor is further arranged to transmit data to the at least one lower node.

3. A relay as claimed in claim 1, wherein the at least one higher level node is a base station, wherein the base station is arranged within a base station time period to transmit data to the relay and receive data from the relay.

4. A relay as claimed in claim 3, wherein the start of the relay time period is offset from the start of the higher node time period.

5. A relay as claimed in claim 3, wherein the relay period is substantially equal to two times the base station time period.

6. A relay as claimed in claim 5, wherein the relay is arranged to receive data transmitted from the base station transmitted during a first base station time period and transmit data to be received by the base station during a second base station time period.

7. A relay as claimed in claim 4, wherein the relay transmits and receives data as orthogonally frequency division multiplexed (OFDM) symbols and wherein the start of the relay time period is offset from the start of the base station time period by more than one OFDM symbol.

8. A relay as claimed in claim 7 wherein the offset is 4 OFDM symbols.

9. A relay as claimed in claim 4, wherein the at least one lower level node comprises a further relay which comprises:
a further relay processor arranged to control the further relay so that within a second relay time period the further relay is arranged to
c) transmit data to a user equipment or lower level node, and transmit data to the relay;
d) receive data from the relay and the user equipment and/or lower level node,
wherein the order of operation is c), d).

10. A relay as claimed in claim 9, wherein the further relay time period is defined from when the further processor is first arranged to transmit data to the user equipment to when the further processor is further arranged to transmit data to the user equipment.

11. A relay as claimed in claim 9, wherein the further relay time period is equal to the relay time period.

12. A relay as claimed in claim 9, wherein the further relay time period is offset from the relay time period.

13. A relay as claimed in claim 9, wherein the processor is arranged to transmit data to the further relay, and receive data from the further relay within the relay time period.

14. A relay as claimed in claim 1, wherein the relay time period comprises a first part period within which the operation a) is carried out and a second part period within which the operation b) is carried out, wherein the first part period and second part period are substantially equal to the base station period

15. A relay as claimed in claim 14, wherein the at least one lower level node comprises a further relay which comprises:
a further relay processor arranged to control the further relay so that within a second relay time period the further relay is arranged to
c) transmit data to a user equipment or further lower level node, and transmit data to the relay;
d) receive data from the relay and the user equipment and/or further lower level node,
wherein the order of operation is c), d) and furthermore the further relay time period comprises a further relay first part period within which the operation c) is carried out and a further relay second part period within which the operation d) is carried out, wherein the further relay first part period and further relay second part period are substantially equal to the base station period.

16. A relay as claimed in claim 3, wherein the relay time period is substantially equal to the base station period.

17. A method for operating a relay, said relay arranged to receive data from and transmit data to at least one higher level node and receive data from and transmit data to at least one lower level node, wherein the method comprises:
a) transmitting data to the at least one lower level node and transmitting data to the at least one higher level node; and
b) receiving data from the at least one higher level node and/or receiving data from the at least one lower level node,
wherein the order of method is a) then b) within a relay time period.

18. A method as claimed in claim 17, wherein the relay time period is defined from when the processor is first arranged to transmit data to the at least one lower level node to when the processor is further arranged to transmit data to the at least one lower node.

19. A method as claimed in claim 17, wherein the at least one higher level node is a base station, wherein the base station is arranged to transmit data to the relay and receive data from the relay within a base station time period.

20. A method as claimed in claim 19, wherein the start of the relay time period is offset from the start of the base station time period.

21. A method as claimed in claim 19, wherein the relay period is substantially equal to two times the base station time period.

22. A method as claimed in claim 21, wherein the relay is arranged to receive data transmitted from the base station transmitted during a first base station time period and transmit data to be received by the base station during a second base station time period.

23. A method as claimed in claim 20, wherein the relay transmits and receives data as orthogonally frequency division multiplexed (OFDM) symbols and wherein the start of the relay time period is offset from the start of the base station time period by more than one OFDM symbol.

24. A method as claimed in claim 23 wherein the offset is 4 OFDM symbols.

25. A method as claimed in claim 20, wherein the at least one lower level node comprises a further relay, and the method further comprises:
c) transmitting data to a user equipment and transmit data to the relay;
d) receiving data from the relay or the user equipment,
wherein the order of operation is c), d) within a further relay period.

26. A method as claimed in claim 25, wherein the further relay time period is defined from when the further processor is first arranged to transmit data to the user equipment to when the further processor is further arranged to transmit data to the user equipment.

27. A method as claimed in claim 17, wherein the further relay time period is equal to the relay time period.

28. A method as claimed in claim 27, wherein the further relay time period is offset from the relay time period.

29. A method as claimed in claim 27, wherein the data received in receiving data from the further relay is received in response to data transmitted in the step of transmitting data from the relay to the further relay within the relay time period.

30. A method as claimed in claim 27, wherein the relay time period comprises a first part period within which a) is carried out and a second part period within which b) is carried out, wherein the first part period and second part period are substantially equal to the base station period.

31. A method as claimed in claim 30, the further relay time period comprises wherein the at least one lower level node comprises a further relay, and the method further comprises:
c) transmitting data to a user equipment and transmitting data to the relay;
d) receiving data from the relay or the user equipment,
wherein the order of operation is c), d) within a further relay period and a further relay first part period within which c) is carried out and a further relay second part period within which d) is carried out, wherein the further relay first part period and further relay second part period are substantially equal to the base station period.

32. A method as claimed in claim 19, wherein the relay time period is substantially equal to the base station period.

33. A network comprising a plurality of relays as claimed in any preceding claim.

34. A computer program arranged to operate a computer to perform a method for operating a relay, said relay arranged to receive data from and transmit data to at least one higher level node and receive data from and transmit data to at least one lower level node, wherein the method comprises:
a) transmitting data to the at least one lower level node and transmitting data to the at least one higher level node; and
b) receiving data from the at least one higher level node and/or receiving data from the at least one lower level node,
wherein the order of method is a) then b) within a relay time period.

35. A relay as claimed in claim 1, wherein the processor is arranged to transmit a signature value associated with the relay.

36. A relay as claimed in claim 35, wherein the processor is arranged to transmit a signature dependent on a message transmitted by the at least one higher level node.

37. A relay as claimed in claim 35, wherein the signature comprises a first OFDM symbol comprising an identifier value.

38. A relay as claimed in claim 37, wherein the signature further comprises a second OFDM symbol comprising a null value.

39. A relay as claimed in claim 37, wherein the first OFDM symbol comprises a training sequence value.

40. A relay as claimed in claim 39, wherein the first OFDM symbol comprises a training sequence value modified by a random or pseudo-random value.
